(19) United States
(12) Patent Application Publication
(10) Pub. No.: US 2003/0019100 A1
(43) Pub. Date: Jan. 30, 2003

(54) Dynamic splitting of connecting rods

(76) Inventor: Gottfried Hoffmann, West Bend, WI (US)

Correspondence Address: Timothy M. Kelley, Michael Best & Friedrich LLP, 100 East Wisconsin Avenue, Milwaukee, WI, 53202-4108, US

(21) Appl. No.: 10/205,785

(22) Filed: Jul. 26, 2002

Related U.S. Application Data
(60) Provisional application No. 60/308,324, filed on Jul. 26, 2001.

(51) Int. Cl. B23P 17/00; B21D 53/84

(52) U.S. Cl. 29/888.09; 29/413; 29/414

(57) ABSTRACT

A method for separating a one-piece connecting rod into a cap and a rod includes forming diametrically opposed notches in the connecting rod bore to define a fracture plane that is substantially parallel to the bore central axis. One portion of the connecting rod is clamped to hold it substantially fixed with respect to the other portion of the connecting rod. An oscillatory load is applied to the other of the portions in a direction that is substantially perpendicular to the fracture plane to develop fatigue cracks in the vicinity of the notches. The fatigue cracks are propagated through the connecting rod by the oscillatory load until the connecting rod is separated into the cap and the rod. An apparatus for performing the method is also disclosed.

### RELATED APPLICATIONS

The present Application claims priority under 35 U.S.C. §119 to a Provisional Patent Application Serial No. 60/308,324, filed on Jul. 26, 2001.

### BACKGROUND OF THE INVENTION

1. Field of the Invention

The invention relates to methods and apparatus for splitting and fracturing objects, and more particularly to methods and apparatus for splitting connecting rods.

2. Related Prior Art

Connecting rods for various types of piston-cylinder devices such as internal combustion engines, compressors, and the like are primarily manufactured using one of the following three material/process combinations: ductile iron alloy castings, wrought steel die forgings, and powdered metal forgings. Improvements to the each of the above processes has lead to “near net shape” production of connecting rods, which has reduced the amount of required finish machining drastically, and resulted in remarkable manufacturing cost reductions.

Substantially all connecting rods include a large end, and a small end. The small end includes a small bore that receives a wrist pin, which pivotally couples the small end to the piston of the piston-cylinder device. The large end includes a large bore that surrounds a crankshaft of the piston-cylinder device. In order to assemble the connecting rod and the crank shaft, many modern designs of piston-cylinder devices (e.g. internal combustion engines) require connecting rods that include a rod portion that defines the small end and one half of the large bore, and a cap portion that defines the other half of the large bore. In this respect, the cap and the rod can be positioned around the crankshaft and then secured together, such that the connecting rod is pivotally coupled to the crankshaft.

Some connecting rods, commonly referred to as “two-piece” connecting rods, are manufactured by forming the rod portion and the cap portion independently of each other. To form the large bore of a two-piece connecting rod, the rod portion and the cap portion are assembled with each other and a precision boring operation is performed. The rod and cap portions are then separated and reassembled onto the crankshaft. The large amount of assembly and disassembly that are required to complete a two-piece connecting rod imposes a significant increase in manufacturing costs.

In connecting rods manufactured using near net shape techniques, the entire connecting rod is manufactured in one piece and the rod and cap portions are split or separated from each other after the large bore has been precisely machined. Once separated, the rod and cap must fit perfectly back together to maintain the dimensions and roundness of the large bore. In this respect, separation of the rod and cap portions by traditional machining operations is excluded because of the variations that would be caused during material removal. If machining operations were utilized to separate the rod and the cap, additional machining operations similar to those described above with respect to two-piece connecting rods would be required, thereby eliminating the economic benefit of the near net shape processes.

To precisely separate the rod and cap portions without effecting the dimensions and roundness of the bore, splitting techniques known as fracture splitting have been developed. In fracture splitting operations, the rod and cap are separated from each other by applying a tensile load that essentially snaps the cap and the rod apart. The most important condition for successfully fracture splitting a connecting rod is for the separation of the rod and cap portions to occur by purely brittle fracture. If any plastic deformation occurs to either the rod or the cap portion during the splitting process, the rod and cap will no longer fit perfectly back together and the dimensions and roundness of the bore will be compromised. There are several patents worldwide that relate to fracture splitting techniques for connecting rods.

Fracture splitting techniques are generally governed by a group of metallurgical principles known collectively as fracture mechanics. According to the principles of fracture mechanics, brittle fracture occurs when a stress-intensity factor at a crack tip reaches a critical value. In substantially all metals, the area of highest stress concentration is achieved at the tip of a sharp crack. A material property known as fracture toughness is used to predict a critical crack length and a critical external load that will result in brittle fracture of a part. Given the above, fracture splitting techniques work best if a notch is formed in the part which provides a high enough stress concentration to guarantee brittle fracture along the splitting plane. The notch can be formed by a machining operation such as honing or laser cutting, or can be forged directly into the part. The powder forging process allows for a notch to be produced in the preform that is partially closed during the subsequent forging operation, thereby producing an internal crack that provides a very high stress concentration.

Regardless of how the notch is formed, the brittleness of the material determines the consistency with which the fracture splitting process can be carried out. Generally, the more brittle the material, the easier it is to control the fracture splitting process such that plastic deformation is reduced and the rod and cap portions fit perfectly together. One drawback to using highly brittle materials however is that the service life of a connecting rod generally decreases as the brittleness of the material is increased. As such, it is desirable to utilize connecting rod materials that are as ductile as possible, yet still fracture in a brittle fashion during the fracture splitting process.

In order to allow the use of connecting rod materials that are more ductile than those used during fracture splitting processes, Canadian patent no. 2,287,140 discloses a process for fracturing connecting rods utilizing resonance-fatigue techniques. A computer model of the one-piece connecting rod to be fractured is utilized to determine the resonant frequencies and mode shapes of the connecting rod. Using these frequencies and mode shapes, the connecting rod is subjected to a series of static and dynamic loads that simulate resonance of the connecting rod. At a specific time during the cyclical deformation of the connecting rod, an impact load is applied in a direction that separates the cap and rod portions from each other. The resonance-fatigue technique improves the splitting process by creating micro-cracks in the connecting rod prior to the application of the impact load. The micro-cracks developed during the harmonic loading period help assure that the connecting rod is fractured in a primarily brittle fashion.

### SUMMARY OF THE INVENTION

Given the above, it is apparent that a connecting rod manufacturing technique that is cost effective, and simple to perform, and that is suitable for manufacturing connecting rods using near net shape methods with increasingly ductile materials is desirable.

While resonance-fatigue techniques have successfully improved on fracture splitting techniques, resonance-fatigue techniques are extremely complicated, and require computational modeling and specialized part fixturing to guarantee success. The additional research and capital costs associated with developing the computational models and the new part fixtures and loading stations may preclude some manufacturers from making connecting rods using resonance-fatigue techniques.

To improve upon known methods for manufacturing connecting rods and other items that are split and subsequently reassembled, the present invention provides . . .

Other features and advantages of the invention will become apparent to those skilled in the art upon review of the following detailed description, claims and drawings.

### BRIEF DESCRIPTION OF THE DRAWINGS

FIG. 1 is a side view of a connecting rod splitting apparatus embodying the invention.

FIG. 2 is a section view taken along line 2-2 of FIG. 1.

FIG. 3 is a graph illustrating the results of dynamic splitting of connecting rods made of three different materials.

Before one embodiment of the invention is explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein is for the purpose of description and should not be regarded as limiting. The use of “including” and “comprising” and variations thereof herein is meant to encompass the items listed thereafter and equivalents thereof as well as additional items.

### DETAILED DESCRIPTION OF A PREFERRED EMBODIMENT

Before describing the invention in detail, it will be helpful to introduce certain metallurgical concepts and equations to facilitate a more complete understanding of the invention.

The present invention deals with dynamically loading and fatigue fracturing substantially any structural part that is fractured into two or more separate pieces, and is then reassembled into a single assembly having substantially the same shape and dimensions as the original, non-fractured part. One of the most useful applications for the fatigue fracturing method of the present invention relates to connecting rods for piston cylinder devices, such as those discussed above in the Background.

As discussed above, fracture mechanics principles suggest that substantially any solid material will break in a brittle fashion when a material crack having a certain length is subjected to a certain tensile stress. The crack length and tensile stress required for brittle fracture of a given part are referred to as the “critical crack length” and the “critical tensile stress” respectively. Generally, as crack length increases, the critical tensile stress required for brittle fracture decreases. Critical tensile stress and critical crack length are related by the following correlation:

K_{IC}=Y*σ_{c}*\sqrt{π*a_{c}} (Equation 1)

with K_{IC}=Fracture Toughness, which is a material property

Y=Geometric Factor, which is determined by the part in question

σ_{c}=Critical Stress

a_{c}=Critical Crack Length

Known fracture splitting techniques utilize fracture mechanics principles by inducing a very high tensile stress in the part. This is generally accomplished by creating a stress concentration in the part in the area that is to be fractured. Stress concentrations are often created in connecting rods either by machining a very sharp V-shaped notch into the part, or by utilizing forging techniques that result in a very sharp crack being formed within the part during the manufacturing process. With respect to critical crack length, as material ductility increases, the critical crack length for brittle fracture also generally increases. It is this relationship that has limited existing fracture splitting techniques to highly brittle materials. In known fracture splitting methods, the critical crack length of certain relatively ductile materials can exceed the thickness of the part that is to be split. As a result, these parts will undergo a high degree of plastic deformation as they are separated into two or more pieces, thereby ruining the precision of any machining that was performed on the part prior to the splitting process. Furthermore, if a ductile material is split and the crack does not reach the critical length, or the stress concentration at the crack tip does not reach the critical value, plastic deformation will take place at the root of the notch (if a machined notch is utilized) or at the tip of the crack (if a forged in crack is utilized). To reduce the occurrence of plastic deformation during fracture splitting, special materials were developed for the fracture splitting process. These special materials are sufficiently brittle such that fracture splitting techniques can be employed with little or no plastic deformation.

Fracture mechanics principles also show that a crack will travel or “propagate” through a part when an oscillating or dynamic load is applied. Cracks that are a result of, and that propagate due to dynamic loading are referred to as “fatigue cracks”. Fatigue cracks are known to propagate through a material when a certain load limit, referred to as a “threshold load” is repeatedly applied to a part. For a given part thickness, the threshold load is generally significantly lower than the load required to induce the critical tensile stress in the part. When the load applied to a part exceeds the threshold load, an existing fatigue crack will grow in length by a certain amount with every load cycle, and will grow at a faster rate as the crack length increases or if the applied load magnitude is increased. By measuring the so called “crack propagation rate”, the amount of crack growth per load cycle can be calculated for each material. This process of crack propagation is governed by the Paris-Erdogan Equation where:

da/dN=C*(ΔK)ⁿ (Equation 2)

with da/dN=crack propagation per load cycle

C & n=constants

ΔK=range of stress concentration, which is correlated to the material stress and crack length by Equation 1.

Given equations 1 and 2 above, the present invention recognizes and exploits the following relationships relating to fatigue crack propagation in materials:

1. Fatigue cracks form within the material with significantly less plastic deformation than cracks formed under static loading.

2. Fatigue cracks propagate within the material along grain boundaries or along certain crystalline planes, thereby producing a very “brittle” appearance of the fractured surface with little or no plastic deformation.

3. The fatigue crack propagation rate, especially for steels, is almost independent of the chemical composition and the other mechanical properties of the material. As a result, a wide variety of materials can be successfully split using the fatigue splitting techniques of the present invention, including materials that might be too ductile for known fracture splitting techniques.

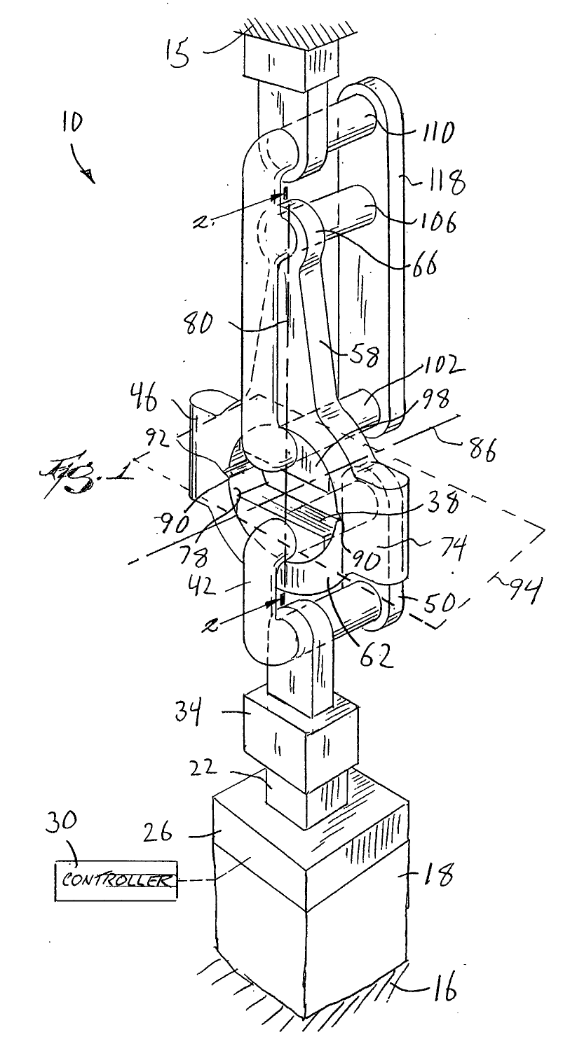

Keeping in mind the technical details presented above, the figures illustrate an exemplary connecting rod splitting apparatus 10 that operates according to the teachings of the present invention. Referring to FIG. 1, the apparatus 10 includes a frame having an upper frame member 15 and a lower frame member 16 (represented schematically) that are sufficiently rigid to support and counteract the various loads created during the connecting rod splitting process. An actuator 18 is coupled to the frame 14 (e.g. to the lower frame member 16 as illustrated) and includes a piston portion 22 and a housing portion 26. The piston portion 22 is movable with respect to the housing portion 26 in response to signals received by the actuator 18 from a control system 30. The actuator 18 preferably includes an internal encoder (not shown) that provides an electrical position signal to the control system 30 that corresponds to the relative position of the piston portion 22 with respect to the housing portion 26. The illustrated actuator 18 is an axial hydraulic actuator, however other types of actuators such as mechanical actuators, pneumatic actuators, magnetic actuators and the like can also be used, and can be configured for use with various types of linkages, gears, and other drive mechanisms as required.

The control system 30 includes suitable circuit components and/or microprocessors that are capable of sending signals to the actuator 18 that cause the piston portion 22 to move with respect to the housing portion 26 in a predetermined manner (e.g. linearly, sinusoidally, and the like). The control system 30 is preferably able to control the movement of the piston portion 22 in response to position signals received from the encoder, and/or in response to the load applied by the piston portion 22 to the other components of the apparatus 10, as will be discussed further below.

In the illustrated embodiment, a load cell 34 is mounted to the end of the piston portion 22 and includes a cradle portion 36. Other embodiments of the invention may position the load cell 34 in alternate locations. The load cell 34 is operable to measure a load that is passed through the cell 34. The load cell 34 preferably communicates with the control system 30 such that the control system 30 can regulate the movement of the piston portion 22 in response to the measured load. For example, the control system 30 may be configured to move the piston portion 22 such that the load measured by the load cell 34 oscillates between two pre-selected load values. This scenario is referred to as “load control” because the movement of the piston portion 22 is governed by the applied load, not by the distance the piston portion 22 is moving. Alternatively, the control system 30 can be configured to move the piston portion 22 such that the piston portion 22 oscillates between two predetermined positions. This scenario is referred to as “strain control” because the amount of strain placed on the part to be split remains substantially constant regardless of the applied load magnitude. Of course, other methods for controlling the movement of the piston portion 22 are possible as well.

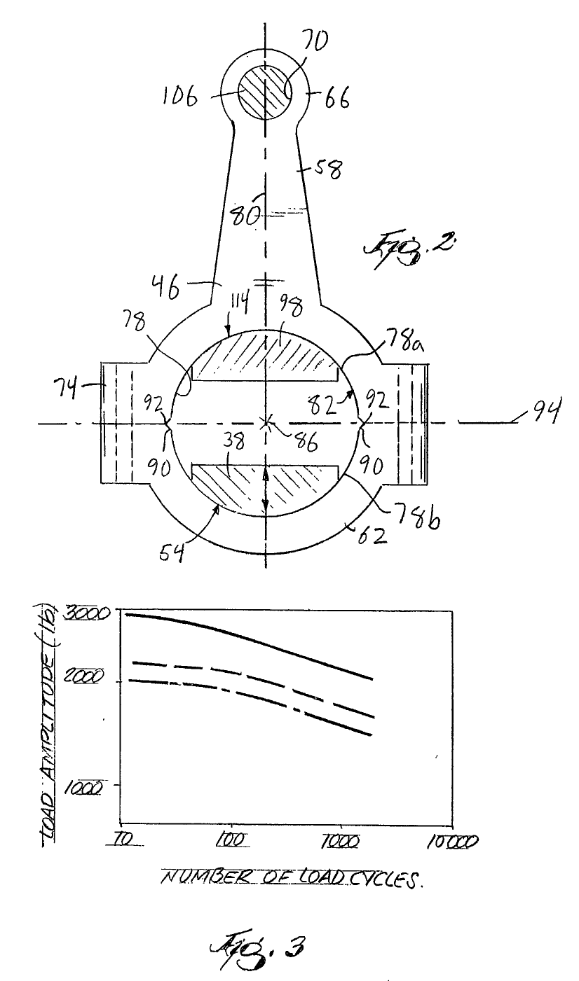

Referring also to FIG. 2, a loading jaw 38 is coupled to the load cell 34. The illustrated loading jaw 38 includes a generally C-shaped portion 42 having one arm coupled to the load cell 34 and the other arm coupled to a part to be split, which in the illustrated embodiment is a connecting rod 46. The loading jaw 38 also includes a retaining plate 50 that receives both arms of the C-shaped portion 42 and reduces the deflection of the C-shaped portion 42 during loading. The C-shaped portion 42 includes an arcuate loading surface 54 that engages the connecting rod 46.

The connecting rod 46 is a one-piece connecting rod and includes a rod portion 58 and a cap portion 62. A small end 66 of the connecting rod 46 defines a small bore 70 that receives a wrist pin (not shown) that pivotally couples a piston element (also not shown) to the small end 66. A large end 74 of the connecting rod 46 defines an aperture in the form of a large bore 78. The connecting rod 46 also includes a longitudinal axis 80 that extends from the small end 66 toward the large end 74. As illustrated, the large bore 78 is surrounded by a generally cylindrical bore surface 82 and defines a bore axis 86. In forming the large bore 78, one preferred method is to form the connecting rod 46 using a near net shape process (e.g. closed or impression die forging or powder forging) which results in an unfinished or “raw” connecting rod that includes an aperture approximating the desired size and shape of the finished bore. A machining operation is then performed to precisely form the large bore 78 to the required diameter. An additional machining operation may also be performed to form the small bore 70. Regardless of the fabrication method of the one-piece connecting rod, the present invention is generally directed to connecting rods and other structural items wherein a feature such as the large bore 78 is at least partially machined before the item is split into separate pieces, such as the rod portion and the cap portion. While it is preferred that most, if not all, of the finish machining be performed before the item is split, machining can also be performed after the splitting process has been completed.

In the illustrated embodiment, a pair of axially extending V-shaped notches 90 having notch tips 92 are formed in the connecting rod 46 and are radially recessed with respect to the bore surface 82. The notches 90 are substantially diametrically opposed to each other and define a fracture plane 94 that substantially divides the large bore 78 into a first half 78a, which is defined by the rod portion 58, and a second half 78b, which is defined by the cap portion 62. While the fracture plane 94 of the illustrated connecting rod 46 is substantially perpendicular to the longitudinal axis 80, it should be appreciated that the notches 90 could be positioned differently such that the fracture plane 94 is angled with respect to the longitudinal axis 80. With respect to connecting rods that are billet machined, die forged, or cast, the notches 90 are generally machined into the bore surface 82 using known machining techniques. The powder forging process however allows the notches 90 to be formed during the forging process, which can result in significantly sharper notch tips 92, which in turn leads to a greater stress concentration and improved splitting characteristics.

In the illustrated embodiment, the cradle portion 36 of the load cell 34 closely receives the cap portion 62 to substantially prevent rotation of the cap portion 62 for reasons that will be discussed further below. The arcuate loading surface 54 engages the second half 78b of the large bore 78 along the bore surface 82. The loading surface 54 and the bore surface 82 are preferably in mating contact along a substantial majority of their length to reduce deformation or damage to the bore surface 82 during the splitting process. Engaging the first half 78a of the large bore 78 is a clamping jaw 98. The illustrated clamping jaw 98 includes a generally E-shaped portion having a first arm 102 that is received by the large bore 78, a second arm 106 that is received by the small bore 70, and a third arm 110 that is coupled to the upper frame member 15. The first arm 102 includes an arcuate clamping surface 114 that engages the first half 78a of the large bore 78 along the bore surface 82. The clamping surface 114 and the bore surface 82 are also in mating contact over a substantial majority of their length to reduce damage to the bore surface during the splitting process. The second arm 106 is provided to accurately position the connecting rod 46 between the frame members 15, 16, and also substantially prevents rotation of the rod portion 58. Preferably however, the second arm 106 does not apply any significant load to the connecting rod 46. A retaining plate 118 includes three apertures that receive the arms 102, 106, 110 and reduces deformation of the clamping jaw 98 during loading.

In some embodiments, the above-described splitting apparatus 10 can include an MTS 20,000 lb. servo-hydraulic testing machine available from MTS Systems Corporation of Eden Prairie Minn. The MTS machine is well suited for the present application because the machine includes the frame and actuator, and is readily fitted with the load cell, and controller components. The loading jaw 38 and the clamping jaw 98 are preferably fabricated from high strength steels and are sufficiently robust to resist deformation during the loading process. The retaining plates 50, 118 can be held in place using pins, threaded fasteners, retaining rings, and the like.

It will be readily apparent to those of skill in the art that certain components, such as the load cell 34 and the actuator 18, could be positioned differently. For example, the load cell 34 could be alternately positioned between the actuator and the lower frame member 16, or between the clamping jaw 98 and the upper frame member 15. Similarly, the actuator could be repositioned such that the clamping jaw 98 effectively becomes the loading jaw, and such that the actuator load is applied to the first half 78a of the bore surface 82 while the second half 78b of the rod surface 82 is held substantially fixed. Furthermore, the actuator 18 could be positioned between the upper and lower frame members 15, 16 such that the frame members move with respect to each other under loading. The apparatus 10 is also not limited to a vertical arrangement as illustrated, the components could be oriented in substantially any way depending upon the particular application.

It is preferred that a substantially purely tensile load be applied to the connecting rod 46. In this regard, the cradle portion 36 of the load cell 34, and the second arm 106 of the clamping jaw 98 are provided to substantially prevent relative rotation of the cap portion 62 and the rod portion 58 as the two portions are split from each other. By preventing such rotational movement, more uniform splitting of the connecting rod 46 can be achieved. For example, if rotation of one or both of the cap portion 62 and the rod portion 58 were permitted, one side of the connecting rod could forseeably be split before the other, resulting in the potential for ductile fracture of the connecting rod.

It should be appreciated that if the fracture plane 94 is angled with respect to the longitudinal axis 80 of the connecting rod 46, the mounting configuration of the loading jaw 38 and the clamping jaw 98 would be adjusted such that loads applied to the connecting rod 46 are applied in a direction that is generally perpendicular to the fracture plane 94. Depending upon how loads are applied to the connecting rod 46, the load cell 34 can be repositioned as required to accurately measure the loads.

Before dynamically splitting the connecting rod 46 using the fatigue fracturing techniques of the present invention, it may be necessary to first determine certain fracturing characteristics of the connecting rod 46 using conventional fracture splitting methods. Variations in connecting rod geometry, materials, and manufacturing methods result in a wide variety of connecting rods having different structural characteristics. By fracture splitting a sample connecting rod, information relating to the load magnitude required to fatigue fracture the connecting rod can be acquired.

With the sample connecting rod positioned in the splitting apparatus 10, the control system 10 is configured to send a signal to the actuator 18 that causes the piston portion 22 to apply a tensile load to the connecting rod by urging the cap portion 62 away from the rod portion 58 at a substantially constant rate. As the piston portion 22 moves, a tensile stress is generated in the connecting rod 46. The tensile stress is highest at the notch tips 92, which concentrate the stress in a highly localized area. As the piston portion 22 moves, the load that is applied to the connecting rod 46 is measured by the load cell 34. For a perfectly brittle fracture, the load magnitude increases generally linearly with the movement of the piston portion 22 until the critical tensile stress is reached. Once the critical tensile stress is reached, the connecting rod 46 splits along the fracture plane, and the rod portion 58 and the cap portion 62 are separated from each other. Note that with the exception of extremely brittle materials, a certain amount of plastic deformation generally occurs at the very beginning of connecting rod fracture. By measuring the applied load as the piston portion 22 moves, the magnitude of the load required to generate the critical tensile stress (termed the “critical load”) can be ascertained. This value is subsequently used to determine the magnitude of a cyclical load that will be applied during the fatigue fracturing process. For connecting rods made of highly ductile materials wherein the critical crack length may exceed the thickness of the connecting rod, the critical load can be determined analytically using Equation 1 above.

Having determined the critical load for the specific type of connecting rod, the apparatus 10 is reconfigured for fatigue fracturing of connecting rods. A new connecting rod 46 is positioned in the apparatus 10, and the control system 30, the actuator 18, and the load cell 34 are configured for operation under load control, strain control, or any other suitable control strategy for fatigue fracturing. Referring first to a load control scenario, the control system signals the piston portion 22 to move until the load cell 34 measures an applied load of about one-half the critical load determined above. This load is referred to as the pre-load or the mean load. With the mean load applied, an oscillatory load amplitude is chosen such that the maximum load applied to the connecting rod is greater than the threshold load for fatigue crack propagation, but less than the critical load. The control system 30 then sends signals to the actuator 18 such that the piston portion 22 oscillates. The piston oscillations are controlled by monitoring the load cell 34 such that the measured load oscillates about the mean load by the selected oscillatory load amplitude.

As the piston portion 22 oscillates, fatigue cracks form at the notch tips 92 and begin to propagate through the connecting rod 46 along the fracture plane 94. It should be appreciated that the fatigue cracks do not form and propagate in a perfectly planar fashion, but propagate generally radially outwardly from the notch tips 92. With each oscillation of the piston portion 22, the fatigue cracks increase in length by a small amount, as determined by Equation 2 above. Eventually, after enough load cycles have occurred, the fatigue cracks propagate all the way through the connecting rod 46 and the rod and cap portions 58, 62 are separated from each other.

The growth rate of the fatigue cracks can be regulated by adjusting the mean load and the load amplitude as desired during the splitting process. For example, certain connecting rods may have geometric and material properties such that as the fatigue crack propagates, the fatigue crack may reach the critical crack length for the maximum load that is applied during piston portion 22 oscillations. If this situation arises, it is possible that the connecting rod may completely fracture upon a single load application, resulting in at least a small amount of plastic deformation. To prevent this, the growth of the fatigue crack can be monitored and the mean load and/or the load amplitude can be adjusted by the control system 30 as the fatigue crack propagates. Generally, as the fatigue crack grows, the load magnitudes (and therefore the stress in the part) are reduced such that Equation 1 is never satisfied and the connecting rod is split substantially entirely by fatigue crack propagation.

If strain control is utilized, monitoring the growth of the fatigue crack may be unnecessary, as the piston portion will move substantially the same distance with every oscillation. As the fatigue cracks propagate through the connecting rod 46, the stiffness of the connecting rod in the loading direction is reduced. As such, the force required to move the piston the predetermined distance is reduced. The result is that the applied load near the end of the splitting process may be extremely small. The strain control method therefore somewhat inherently monitors fatigue crack growth to assure that the threshold load is not reached and that the connecting rod is split substantially entirely by fatigue crack propagation.

Once the cap portion 62 and the rod portion 58 are separated from each other, the portions can be reassembled to each other by mating the fracture surfaces formed during the splitting process to each other. The somewhat jagged and irregular fracture surfaces are matable with each other such that the diameter of the large bore 78 when the rod and cap are reassembled is substantially the same as it was before the connecting rod 46 was split.

The number of load cycles required to completely split the connecting rod is generally a function of the mean load magnitude and the load amplitude, as well as the geometric and material properties of the connecting rod. To further illustrate the application of the principles and teachings presented above, a brief description of testing and analysis performed by the inventor is outlined below.

Tests were performed using powder forged connecting rods having substantially identical geometry. Two powder-forged steels were utilized, P/F-11C59 and P/F-11 C47 per ASTM B 848 standards. Half of the connecting rods made of P/F-11C59 were provided with machined notches, while the other half were provided with notches formed during the powder forging process. All of the P/F-11C47 connecting rods had notches formed during the powder forging process. Tests of the connecting rods using fracture splitting techniques were performed to determine the critical load for each of the three types of connecting rods. The piston portion 22 of the actuator 18 was moved at a substantially constant rate of about 0.1 mm/sec and the applied load was measured by the load cell 34. The critical loads for each type of connecting rod were as follows:

| | |
|---|---|
| P/F-11C59 machined notch | 26.5 kN |
| P/F-11C59 forged notch | 21.2 kN |
| P/F-11C47 forged notch | 21.8 kN |

Having determined the critical load magnitudes, several samples of each type of connecting rod were fatigue fractured using different load amplitudes. The mean load magnitude for each test was held substantially constant at about one-half the critical load magnitude. FIG. 3 illustrates the number of load cycles required to completely fracture each type of connecting rod as a function of the load amplitude. The solid line corresponds to the connecting rod made of P/F11C59 and having the machined notch, the dashed line corresponds to the connecting rod made of P/F11C47, and the dot-dashed line corresponds to the connecting rod made of P/F11C59 and having the forged notch. For each connecting rod type, as the load amplitude increases, the number of load cycles required to fracture the connecting rod decreases. The tests were conducted using a constant load oscillation frequency of about 10 Hz, however other load oscillation frequencies, including variable load oscillation frequencies can be used as well.

Given the experimental results and parameters, it is apparent that the fatigue fracturing of connecting rods can be carried out in a relatively short period of time. For example, for an oscillation frequency of 10 Hz, 100 load cycles will take approximately 10 seconds. As indicated in FIG. 3, the load amplitude can be manipulated such that fewer than 100 load cycles are required to completely fracture the connecting rod 46. In addition, by monitoring fatigue crack growth and varying the mean load, load amplitude, and oscillation frequency during the splitting process, the amount of time required to fracture the connecting rod can be reduced even further. By manipulating the various load and frequency parameters, fatigue fracturing techniques can be readily optimized for use in mass production manufacturing of connecting rods.

The invention as described above has been directed to the fabrication of connecting rods but is not limited in that regard. The invention is suitable for other applications and can be applied to substantially any other structural part. It is to be understood that the invention is not limited to the details of construction and the arrangements of components set forth in the description or illustrated in the drawings. The invention is capable of other embodiments and of being practiced or being carried out in various ways. Also, it is to be understood that the phraseology and terminology used herein is for the purpose of description and should not be regarded as limiting.

Various features of the invention are set forth in the following claims.

What is claimed is:

1. A method for separating a one-piece metallic item into two pieces, the method comprising:
forming an aperture in the item, the aperture surrounded by an aperture surface and defining an aperture axis;
selecting a fracture plane that is substantially aligned with the aperture axis, the fracture plane dividing the item into a first portion and a second portion;
forming two axially extending notches that are recessed with respect to the aperture surface and substantially aligned with the fracture plane;
clamping the first portion to substantially fix the first portion;
applying a cyclical load to the second portion in a direction that is substantially perpendicular to the fracture plane to urge the second portion away from the first portion, thereby forming radially outwardly extending fatigue cracks in the vicinity of the notches and propagating the fatigue cracks through the item until the first and second portions are separated from each other.

2. The method of claim 1, further comprising securing the first and second portions against relative rotational movement with respect to each other.

3. The method of claim 1, wherein the aperture is substantially circular in section and the notches are substantially diametrically opposed from each other.

4. The method of claim 1, wherein prior to applying the cyclical load, a pre-load is applied to the second portion in a direction that is perpendicular to the fracture plane.

5. The method of claim 1, wherein forming the aperture comprises machining the aperture.

6. The method of claim 1, wherein forming the notches comprises forging the notches into the metallic item.

7. A method for separating a one-piece connecting rod into a rod and a cap, the one-piece connecting rod defining a through bore and a bore axis, the method comprising:
forming two diametrically opposed and axially extending notches in the connecting rod to define a fracture plane that extends through the through bore and is substantially parallel to the bore axis, the fracture plane substantially defining a boundary between a portion of the connecting rod that will become the rod and a portion of the connecting rod that will become the cap;
clamping one of the portions to hold the one portion substantially fixed with respect to the other of the portions;
applying a load having a load magnitude to the other of the portions in a direction that is substantially perpendicular to the fracture plane; and
repeatedly changing the load magnitude to develop fatigue cracks in the vicinity of the notches and to propagate the fatigue cracks through the connecting rod until the portions are separated into the cap and the rod.

8. The method of claim 7, wherein applying the load comprises applying a mean load having a mean load value, and wherein repeatedly changing the load magnitude comprises oscillating the load magnitude about the mean load value by a load amplitude.

9. The method of claim 8, wherein oscillating the load magnitude about the mean load value comprises oscillating the load magnitude at a frequency of about 10 Hz.

10. The method of claim 7, wherein the through bore includes a bore surface, and wherein forming the notches comprises forming a recess in the bore surface.

11. The method of claim 10, wherein applying the load comprises applying a load to the bore surface.

12. The method of claim 7, wherein forming the notches comprises at least one of machining the notches into the connecting rod and forging the notches into the connecting rod.

13. The method of claim 7, wherein clamping one of the portions comprises clamping the portion that will become the rod.

14. The method of claim 7, further comprising securing the first and second portions against relative rotation with respect to each other.

15. A method for making a connecting rod, the method comprising:
forming a one-piece connecting rod including a large end and a small end;
machining a crankpin bore in the large end along a bore axis to form an axially inwardly facing bore surface;
selecting a fracture plane that substantially bisects the crankpin bore and is substantially parallel to the bore axis, the fracture plane substantially defining a boundary between a cap portion and a rod portion of the one-piece connecting rod;
forming two axially extending notches that are recessed with respect to the bore surface and substantially aligned with the fracture plane, the notches including notch tips;
cyclically moving the cap portion and the rod portion with respect to each other along an axis that is substantially perpendicular to the fracture plane to develop fatigue cracks at the notch tips; and
propagating the fatigue cracks through the connecting rod in radially opposed directions that are substantially parallel to the fracture plane to separate the cap portion from the rod portion.

16. The method of claim 15, wherein forming the one-piece connecting rod comprises at least one of casting, open die forging, and powder forging the one-piece connecting rod.

17. The method of claim 15, wherein forming the one-piece connecting rod comprises forming a large bore in the large end, and wherein machining the crankpin bore comprises finish machining the large bore.

18. The method of claim 15, wherein the one-piece connecting rod includes a longitudinal axis extending from the large end to the small end, and wherein selecting the fracture plane comprises selecting a fracture plane that is substantially perpendicular to the longitudinal axis.

19. The method of claim 15, wherein forming the notches includes machining V-shaped notches into the bore surface.

20. The method of claim 15, wherein forming the notches includes forging the notches into the bore surface.

21. The method of claim 15, wherein cyclically moving the cap portion and the rod portion with respect to each other comprises applying a load having a load magnitude that is substantially equal to a mean load value to the cap portion, and oscillating the load magnitude about the mean load value by a load amplitude.

22. The method of claim 21, wherein oscillating the load magnitude comprises oscillating the load magnitude at a frequency of about 10 Hz.

23. The method of claim 15, wherein cyclically moving the cap portion and the rod portion with respect to each other comprises applying a cyclical load to at least one of the portions in a direction that is substantially perpendicular to the fracture plane.

24. The method of claim 15, further comprising securing the cap and rod portions against relative rotation with respect to each other.

23. An apparatus for separating a one-piece connecting rod into a cap and a rod, the one-piece connecting rod having a cap portion and a rod portion on opposite sides of a fracture plane, the apparatus comprising:
at least one clamping jaw for holding one of the cap portion and the rod portion substantially fixed with respect to the other portion;
a loading jaw for engaging the other portion and transmitting a load thereto;
an actuator operable to move the loading jaw in a loading direction that is substantially perpendicular to the fracture plane; and
a controller communicating with the actuator for control thereof, the controller operable to oscillate the actuator, thereby applying a cyclical load to the other portion,
wherein in response to the cyclical load, fatigue cracks form in the connecting rod along the fracture plane and propagate through the connecting rod to form the cap and the rod.

24. The apparatus of claim 23, wherein the actuator is a hydraulic actuator.

25. The apparatus of claim 23, wherein the connecting rod includes a large end defining a crankpin bore, and a small end defining a wrist pin bore, and wherein the clamping jaw engages the crankpin bore on one side of the fracture plane, and the loading jaw engages the crankpin bore on the other side of the fracture plane.

26. The apparatus of claim 23, further comprising a load sensor communicating with the controller and operable to sense the load transmitted by the loading jaw.
